(19) United States
(12) Patent Application Publication
(10) Pub. No.: US 2009/0279984 A1
(43) Pub. Date: Nov. 12, 2009

(54) BICYCLE DRIVE UNIT AND FASTENER THEREOF

(76) Inventor: Yung-Chi Wu, Taichung City (TW)

Correspondence Address: Chien-Hui Su, P. O. Box 70-121 Taichung, Taichung City, 40899, TW

(21) Appl. No.: 12/116,225

(22) Filed: May 7, 2008

(51) Int. Cl. F16B 35/04; B62M 1/02

(52) U.S. Cl. 411/393; 474/160

(57) ABSTRACT

A bicycle drive unit includes a crank having multiple branched radially extending from one end thereof. Each branch has a through hole defined therein. A chain wheel set is laterally mounted to the branches of the crank. The chain wheel set has multiple threaded holes defined therein and each threaded hole co-axially aligning with a corresponding one of the multiple through holes in the crank. A fastener is screwed into a corresponding one of the threaded holes in the chain wheel set after extending through a corresponding one of the multiple through holes in the crank for assembling the crank and the chain wheel set.

### BACKGROUND OF THE INVENTION

1. Field of the Invention

The present invention relates to a bicycle drive unit and fastener thereof, and more particularly to a bicycle drive unit and fastener thereof, wherein the fastener has a polygonal blind hole longitudinally defined therein.

2. Description of Related Art

A conventional bicycle drive unit and a fastener thereof in accordance with the prior art shown in FIGS. 7 and 8 comprises

With reference to FIGS. 7 and 8 the show a conventional bicycle drive unit and a fastener thereof, the conventional bicycle drive unit includes a chain wheel set (30′) having a first chain wheel and a second chain wheel, wherein the first chain wheel has a diameter greater than that of the second chain wheel. A crank (20′) is laterally mounted to the chain wheel set (30′). The crank (20′) has multiple branches (21′) radially extending from one end thereof and sandwiched between the first chain wheel and the second chain wheel. The abutment of each branch (21′) and the chain wheel set (30′) has a through hole (300) for securely receiving the fastener. The fastener includes a first element (50) and a second element (60) longitudinally connected to each other. The first element (50) has a hexagon hole (51) centrally longitudinally defined therein and extending therethrough. The first element (50) has a threaded outer periphery. The second element (60) has a hollow structure and a threaded inner periphery formed thereon such that the second element (60) is screwed onto the first element (50) for mounting the chain wheel set (30′) and the branches (21) together.

Each of the first element (50) and the second element (60) of the conventional fastener for crank (20′) and chain wheel set (30′) has a hollow structure such that the hexagon hole (51) is visual and the mud may silt up the hexagon hole (51). As a result, the conventional fastener may be easily eroded.

The present invention has arisen to mitigate and/or obviate the disadvantages of the conventional bicycle drive unit and fastener thereof.

### SUMMARY OF THE INVENTION

The main objective of the present invention is to provide an improved bicycle drive unit and fastener thereof foe providing an easy operation and a complete appearance.

To achieve the objective, the bicycle drive unit in accordance with the present invention comprises a crank having multiple branched radially extending from one end thereof. Each branch has a through hole defined therein. A chain wheel set is laterally mounted to the branches of the crank. The chain wheel set has multiple threaded holes defined therein and each threaded hole co-axially aligning with a corresponding one of the multiple through holes in the crank. A fastener is screwed into a corresponding one of the threaded holes in the chain wheel set after extending through a corresponding one of the multiple through holes in the crank for assembling the crank and the chain wheel set. The fastener includes a head having a closed top face formed thereon. A shank longitudinally and centrally extends from the head opposite to the closed top face and having a diameter smaller than that of the head. The shank having a threaded outer periphery and a distal end formed on a free end of the shank, wherein the shank is screwed into the corresponding one of the threaded holes for assembling the bicycle drive unit. A polygonal blind hole is longitudinally and centrally defined in the distal end of the shank. The polygonal blind hole is provided to receive a head of a wrench for a labor-saving operation.

Further benefits and advantages of the present invention will become apparent after a careful reading of the detailed description with appropriate reference to the accompanying drawings.

### BRIEF DESCRIPTION OF THE DRAWINGS

FIG. 1 is a first perspective view of a fastener for bicycle drive unit in accordance with the present invention;

FIG. 2 is second perspective view of the fastener for bicycle drive unit in accordance with the present invention;

FIG. 3 is a third perspective view of the fastener for bicycle drive unit in accordance with the present invention in partial cross-section;

FIG. 4 is a perspective view of a bicycle drive unit and fastener thereof in accordance with the present invention;

FIG. 5 is a partially enlarged view of FIG. 4;

FIG. 6 is a partially cross-sectional view of the bicycle drive unit in accordance with the present invention;

FIG. 7 is a perspective view of a conventional bicycle drive unit and fastener thereof in accordance with the prior art; and

FIG. 8 is a partially exploded perspective of the conventional bicycle drive unit and fastener thereof in FIG. 7.

### DETAILED DESCRIPTION OF THE INVENTION

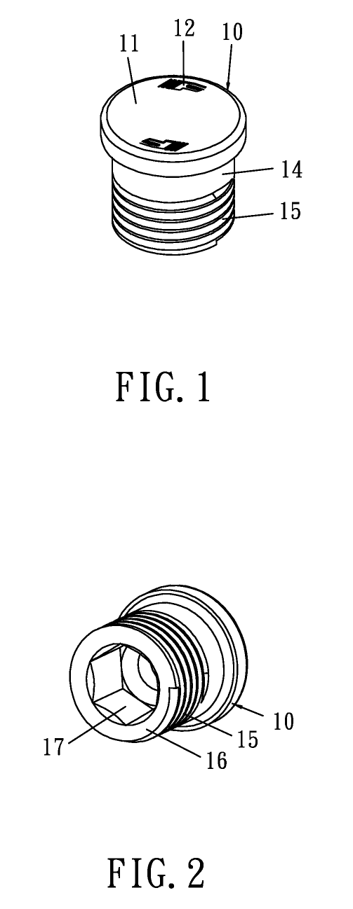

Referring to the drawings and initially to FIG. 1, a fastener for bicycle drive unit in accordance with the present invention comprises has a head (10) and a shank (14) longitudinally extending from one side of the head (10), wherein the shank (14) has a diameter smaller than that of the head (10). The head (10) has a closed top face (11) and the shank (14) has a threaded outer periphery (15).

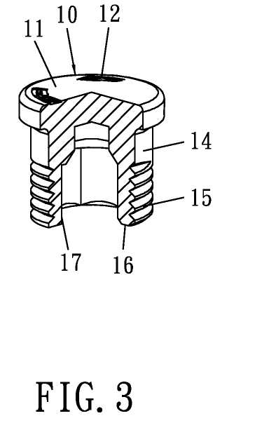

Further with reference to FIGS. 2 and 3, the head (10) has a solid structure. In the preferred embodiment of the present invention, the head (110) has a round outline. At least one indicating zone (12) is formed on the closed top face (11) for indicating the trademark, character or the standard of the threaded outer periphery (15).

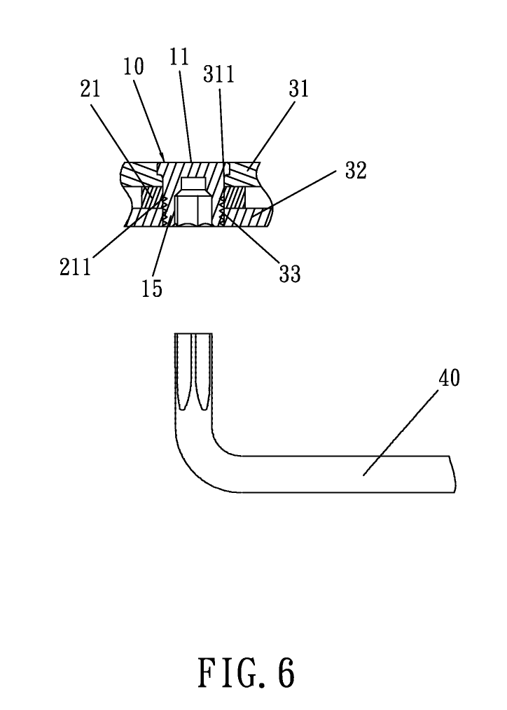

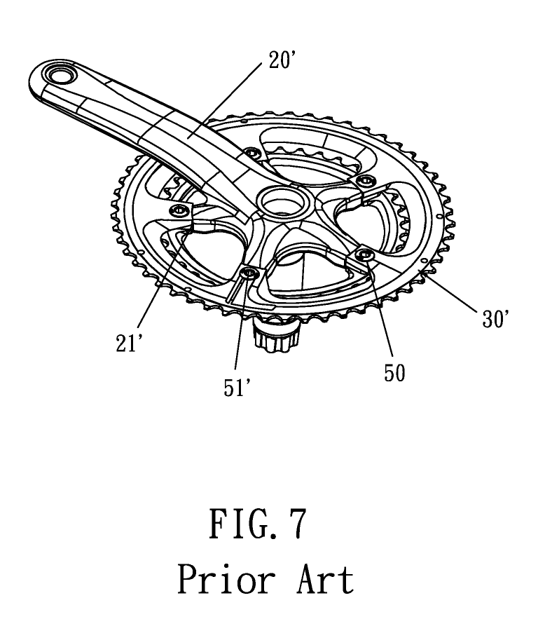

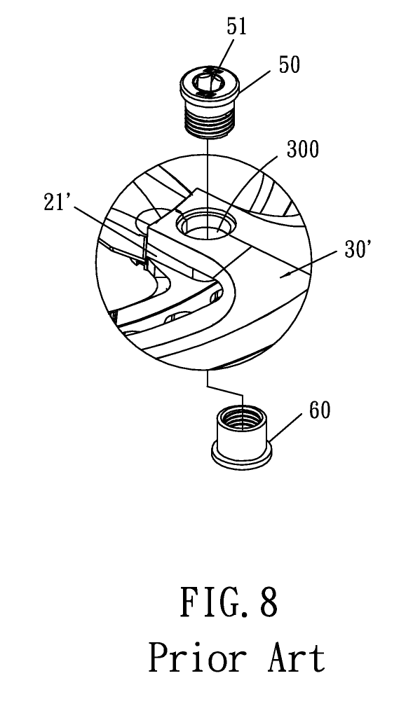

The shank (14) has a distal end (16) opposite to the head (10) and has a polygonal blind hole (17) centrally and longitudinally defined therein. In the preferred embodiment of the present invention, the polygonal blind hole (17) is a hexagon hole and adapted to partially received a hexagon wrench (40) for easily operating the fastener, as shown in FIG. 6.

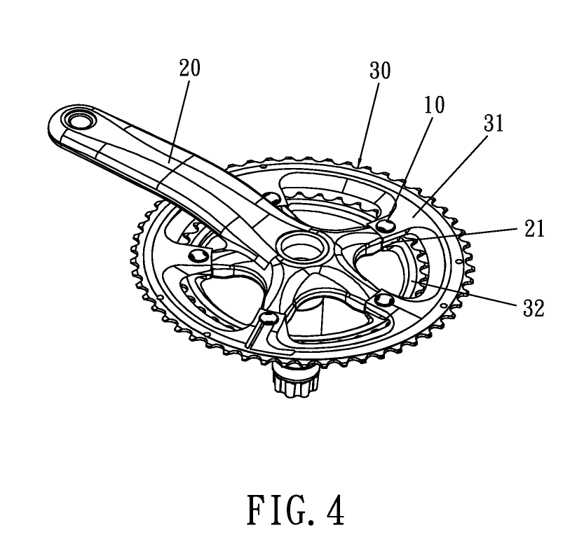

With reference to FIGS. 4-6, the fastener of the present invention is provided to fasten a bicycle drive unit that includes a crank (20) and a chain wheel set (30). In the preferred embodiment of the present invention, the chain wheel set (30) includes a first chain wheel (31) and a second chain wheel (32) laterally and co-axially connected to each other, wherein the first chain wheel (31) has a diameter greater than that of the second chain wheel (32). The first chain wheel (31) has multiple countersinks (311) defined therein and extending therethrough, and the second china wheel (32) has multiple threaded hole (33) defined therein and extending therethrough, wherein each countersink (311) co-axially aligns with a corresponding one of the multiple threaded holes (33) in the second chain wheel (32). The crank (20) has multiple branches (21) radially extending from one end thereof and sandwiched between the first chain wheel (31) and the second chain wheel (32). Each branch (21) has a through hole (211) defined therein and communicating with a corresponding one of the multiple countersink (311) in the first chain wheel (31) and the threaded hole (33) in the second chain wheel (32).

When assembling the drive unit by using the fastener hereinbefore, the shank (14) sequentially extends through the countersink (311) in the first chain wheel (31) and the through hole (311) in the branch (31) of the crank (20), and is screwed into the threaded hole (33) in the second chain wheel (32).

With reference to FIGS. 2, 4 and 6, the operator can tightly secured the fastener into the threaded hole (33) in the second chain wheel (32) with the chain wheel set (30) and the crank (20) by using a wrench (40), which has one end engaged into the polygonal blind hole (17), after the shank (14) of the fastener sequentially extending through the countersink (311) in the first chain wheel (31) and the through hole (211) in the branch (21) of the crank (20).

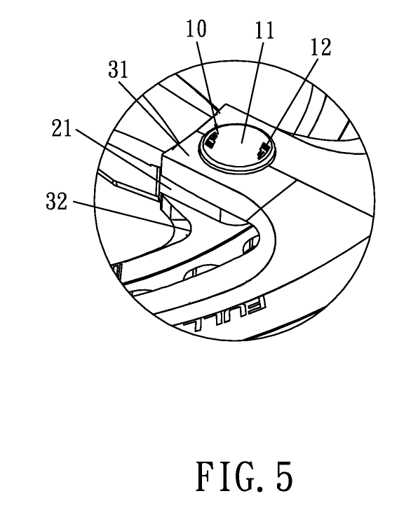

With reference to FIGS. 4 and 5, the head (10) of the fastener is received in the countersink (311) such that the present invention only appears a complete and smooth outer periphery for promoting a vision effect of the bicycle drive unit. In addition, the indicating zone (12) formed on the closed top face (11) can indicate the trademark, character or the standard of the threaded outer periphery (15) as a multi-functional advertisement. Furthermore, the second element of the conventional fastener, as described above, is unnecessary to the present invention. As a result, the operating processes and the structure of the present invention are simplified.

Although the invention has been explained in relation to its preferred embodiment, it is to be understood that many other possible modifications and variations can be made without departing from the spirit and scope of the invention as hereinafter claimed.

What is claimed is:

1. A fastener comprising:
a head having a closed top face formed thereon;
a shank longitudinally and centrally extending from head opposite to the closed top face and having a diameter smaller than that of the head, the shank having a threaded outer periphery and a distal end formed on a free end of the shank; and
a polygonal blind hole longitudinally and centrally defined in the distal end of the shank, the polygonal blind hole adapted to receive a head of a wrench for a labor-saving operation.

2. The fastener as claimed in claim 1, wherein the head has at least one indicating zone formed thereon for indicating information of the fastener.

3. The fastener as claimed in claim 1, wherein the polygonal blind hole is a hexagon blind hole.

4. The fastener as claimed in claim 1, wherein the head has a round outline.

5. The fastener as claimed in claim 2, wherein the polygonal blind hole is a hexagon blind hole.

6. The fastener as claimed in claim 2, wherein the head has a round outline.

7. The fastener as claimed in claim 3, wherein the head has a round outline.

8. A bicycle drive unit comprising:
a crank having multiple branches radially extending from one end thereof, each branch having a through hole defined therein;
a chain wheel set laterally mounted to the branches of the crank, the chain wheel set having multiple threaded holes defined therein and each threaded hole co-axially aligning with a corresponding one of the multiple through holes in the crank; and
a fastener screwed into a corresponding one of the threaded holes in the chain wheel set, the fastener including a head having a closed top face formed thereon, a shank longitudinally and centrally extending from head opposite to the closed top face and having a diameter smaller than that of the head, the shank having a threaded outer periphery and a distal end formed on a free end of the shank, wherein the shank is screwed into the corresponding one of the threaded holes for assembling the bicycle drive unit, a polygonal blind hole longitudinally and centrally defined in the distal end of the shank, the polygonal blind hole adapted to receive a head of a wrench for a labor-saving operation.

9. The bicycle drive unit as claimed in claim 8, wherein the head has at least one indicating zone formed thereon for indicating information of the fastener.

10. The bicycle drive unit as claimed in claim 8, wherein the polygonal blind hole is a hexagon blind hole.

11. The bicycle drive unit as claimed in claim 8, wherein the head has a round outline.

12. The bicycle drive unit as claimed in claim 9, wherein the polygonal blind hole is a hexagon blind hole.

13. The bicycle drive unit as claimed in claim 9, wherein the head has a round outline.

14. The bicycle drive unit as claimed in claim 10, wherein the head has a round outline.

15. The bicycle drive unit as claimed in claim 8, wherein the chain wheel set includes a first chain wheel and a second chain wheel, the multiple threaded holes defined in the second chain wheel and the first chain wheel having multiple countersink defined therein, each countersink in the first chain wheel co-axially aligning with a corresponding one of the multiple threaded holes in the second chain wheel.

16. The bicycle drive unit as claimed in claim 9, wherein the chain wheel set includes a first chain wheel and a second chain wheel, the multiple threaded holes defined in the second chain wheel and the first chain wheel having multiple countersink defined therein, each countersink in the first chain wheel co-axially aligning with a corresponding one of the multiple threaded holes in the second chain wheel.

17. The bicycle drive unit as claimed in claim 10, wherein the chain wheel set includes a first chain wheel and a second chain wheel, the multiple threaded holes defined in the second chain wheel and the first chain wheel having multiple countersink defined therein, each countersink in the first chain wheel co-axially aligning with a corresponding one of the multiple threaded holes in the second chain wheel.

18. The bicycle drive unit as claimed in claim 11, wherein the chain wheel set includes a first chain wheel and a second chain wheel, the multiple threaded holes defined in the second chain wheel and the first chain wheel having multiple countersink defined therein, each countersink in the first chain wheel co-axially aligning with a corresponding one of the multiple threaded holes in the second chain wheel.

19. The bicycle drive unit as claimed in claim 12, wherein the chain wheel set includes a first chain wheel and a second chain wheel, the multiple threaded holes defined in the second chain wheel and the first chain wheel having multiple countersink defined therein, each through hole in the first chain wheel co-axially aligning with a corresponding one of the multiple threaded holes in the second chain wheel.

20. The bicycle drive unit as claimed in claim 13, wherein the chain wheel set includes a first chain wheel and a second chain wheel, the multiple threaded holes defined in the second chain wheel and the first chain wheel having multiple countersink defined therein, each countersink in the first chain wheel co-axially aligning with a corresponding one of the multiple threaded holes in the second chain wheel.
